(19) United States
(12) Patent Application Publication
(10) Pub. No.: US 2008/0309633 A1
(43) Pub. Date: Dec. 18, 2008

(54) Touch-sensitive display

(75) Inventors: Steve Porter Hotelling, San Jose, CA (US); John Z. Zhong, Cupertino, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(73) Assignee: Apple Inc., Cupertino, CA (US)

(21) Appl. No.: 11/818,498

(22) Filed: Jun. 13, 2007

(51) Int. Cl. G06F 3/041

(52) U.S. Cl. 345/173; 381/386; 455/422.1

(57) ABSTRACT

A substantially transparent mutual-capacitance touch sensor panel is disclosed having sensors fabricated on a single side of a substrate for detecting multi-touch events. Substantially transparent row and column traces can be formed on the same side of the substrate, separated by a thin dielectric material, using diamond, rectangular, or hexagonal rows and columns. Dummy shapes of the same material as the row and column traces can be formed alongside the rows and columns to provide optical uniformity. The metal traces in the border areas used to route the rows to the short edge of the substrate can also be formed on the same side of the substrate as the rows and columns. The metal traces can allow both the rows and columns to be routed to the same short edge of the substrate so that a small flex circuit can be bonded to only one side of the substrate.

### FIELD OF THE INVENTION

This relates generally to input devices for computing systems, and more particularly, to a mutual-capacitance multi-touch sensor panel capable of being fabricated on a single side of a substrate.

### BACKGROUND OF THE INVENTION

Many types of input devices are presently available for performing operations in a computing system, such as buttons or keys, mice, trackballs, touch sensor panels, joysticks, touch screens and the like. Touch screens, in particular, are becoming increasingly popular because of their ease and versatility of operation as well as their declining price. Touch screens can include a touch sensor panel, which can be a clear panel with a touch-sensitive surface. The touch sensor panel can be positioned in front of a display screen so that the touch-sensitive surface covers the viewable area of the display screen. Touch screens can allow a user to make selections and move a cursor by simply touching the display screen via a finger or stylus. In general, the touch screen can recognize the touch and position of the touch on the display screen, and the computing system can interpret the touch and thereafter perform an action based on the touch event.

One limitation of many conventional touch sensor panel technologies is that they are only capable of reporting a single point or touch event, even when multiple objects come into contact with the sensing surface. That is, they lack the ability to track multiple points of contact at the same time. Thus, even when two points are touched, these conventional devices may only identify a single location, which is typically the average between the two contacts (e.g. a conventional touchpad on a notebook computer provides such functionality). This single-point identification is a function of the way these devices provide a value representative of the touch point, which is generally by providing an average resistance or capacitance value.

Some state-of-the-art touch sensor panels can detect multiple touches and near touches (within the near-field detection capabilities of their touch sensors) occurring at about the same time, and identify and track their locations. Examples of these so-called “multi-touch” sensor panels are described in Applicant's co-pending U.S. application Ser. No. 10/842,862 entitled “Multipoint Touchscreen,” filed on May 6, 2004 and published as U.S. Published Application No. 2006/0097991 on May 11, 2006, the contents of which are incorporated by reference herein.

Multi-touch sensor panel designs having row and column traces formed on the bottom and top sides of an Indium Tin Oxide (ITO) substrate (referred to herein as double-sided ITO or DITO multi-touch sensor panels), can be expensive to manufacture. One reason that DITO multi-touch sensor panels can be so expensive to manufacture is that thin-film processing steps must be performed on both sides of the glass substrate. However, because current fabrication machinery is designed to process only one side of a substrate as it is moved along by rollers, belts, or other means, special steps must be taken to protect the processed side of the substrate while being transported face down through the fabrication machinery. For example, a protective layer (e.g. photoresist) can be formed over a first processed side of the substrate while a second unprocessed side is being processed, to be removed after completion of the processing of the second side.

Another reason that DITO touch panels can be expensive is the cost of flex circuit fabrication and bonding. As shown in FIG. 1, DITO multi-touch sensor panel 100 can have column traces 102, that can terminate at a short edge 104 of substrate 106, requiring flex circuit 124 having wide flex circuit portion 108 extending the full width of the short edge that can bond to bond pads 110 on the top side of the substrate.

In addition, it is undesirable to have column and row traces 102 and 112, respectively, cross over each other at bonding areas 114, or bond pads 110 and 118 on directly opposing sides of substrate 106 because such areas would generate unwanted stray mutual capacitance and coupling of signals. Therefore, row traces 112, which can be routed to the same short edge 104 of substrate 106 using metal traces 116 running along the borders of the substrate, can be routed to pads 118 at the extreme ends of the substrate. This in turn can require wide flex circuit portion 120 extending the full width of the short edge that can bond to bond pads 118 on the bottom side of the substrate. Even so, a grounded shield layer 122 can be formed along with bond pads 118 on the bottom side of substrate 106 and directly opposing bond pads 110 to reduce stray mutual capacitance.

Because both connector ends of flex circuit 124 can be approximately the full width of the short edge of substrate 106, a large flex circuit 124 can be required. Moreover, the actual step of bonding flex circuit 124 to opposite sides of the same short edge 104 of substrate 106 can create bonding reliability issues due to the potential for excessive heat and pressure.

By comparison, the flex circuit of a conventional liquid crystal display (LCD) assembly can be generally much narrower than the short edge of its substrate, can bond to only one side of a substrate (which makes for much easier bonding), and can be much smaller because it does not need to span the entire width of the substrate and connect to both sides of the substrate.

### SUMMARY OF THE INVENTION

This relates to a substantially transparent mutual-capacitance touch sensor panel having sensors fabricated on a single side of a substrate for detecting multi-touch events (the touching of multiple fingers or other objects upon a touch-sensitive surface at distinct locations at about the same time). To avoid having to fabricate substantially transparent row and column traces on opposite sides of the same substrate, embodiments of the invention can form the row and column traces on the same side of the substrate, separated by a thin dielectric material, using diamond, rectangular, or hexagonal rows and columns. Dummy shapes of the same material as the row and column traces can be formed alongside the rows and columns to provide optical uniformity. The metal traces in the border areas used to route the rows to the short edge of the substrate can also be formed on the same side of the substrate as the rows and columns. The metal traces can allow both the rows and columns to be routed to the same short edge of the substrate so that a small flex circuit can be bonded to a small area on only one side of the substrate.

### BRIEF DESCRIPTION OF THE DRAWINGS

FIG. 1 illustrates an exemplary DITO multi-touch sensor panel having column traces that can terminate at a short edge of the substrate, requiring a larger and more expensive flex circuit.

FIG. 2a illustrates an exemplary arrangement of diamond-shaped rows and columns on the same side of a single substrate according to one embodiment of this invention.

FIG. 2b illustrates an exemplary pixel generated from diamond-shaped rows and columns on the same side of a single substrate according to one embodiment of this invention.

FIG. 3a illustrates an exemplary arrangement of diamond-shaped rows and columns, with isolated “dummy” diamonds formed between the rows and columns according to one embodiment of this invention.

FIG. 3b illustrates exemplary column, row, and dummy diamonds according to one embodiment of this invention.

FIG. 4a illustrates an exemplary arrangement of rectangular-shaped rows and columns, with isolated “dummy” squares and rectangles formed between the rows and columns according to one embodiment of this invention.

FIG. 4b illustrates an exemplary column and row according to one embodiment of this invention.

FIG. 5a illustrates an exemplary arrangement of hexagon-shaped rows and columns, with isolated “dummy” squares and hexagons formed between the rows and columns according to one embodiment of this invention.

FIG. 5b illustrates an exemplary column and row according to one embodiment of this invention.

FIG. 6a illustrates an exemplary timing diagram of LCD display activity versus touch sensor panel scan activity.

FIG. 6b illustrates an exemplary timing diagram of LCD display activity versus touch sensor panel scan activity, where the timing of the LCD display activity and touch panel scanning is synchronized so that scanning only occurs when the LCD display is inactive, during the vertical blanking period, according to one embodiment of this invention.

FIG. 7 illustrates an exemplary touchscreen stackup according to one embodiment of this invention.

FIG. 8 illustrates an exemplary detailed view of the stackup of the rows and columns formed on a single side of a substrate according to one embodiment of this invention.

FIG. 9 illustrates a top view of an exemplary substrate with rows and columns formed on the top side and connected at a single end according to one embodiment of this invention.

FIG. 10 illustrates an expanded view of exemplary metal traces as they are routed to the bond pads at a bottom short edge of a substrate according to one embodiment of this invention.

FIG. 11 illustrates a top view of an exemplary substrate with rows and columns formed on the top side and with rows connected at both ends according to one embodiment of this invention.

FIG. 12 illustrates an exemplary computing system operable with the sensor panel and touchscreen stackups according to embodiments of this invention.

FIG. 13a illustrates an exemplary mobile telephone that can include the sensor panel and touchscreen stackups and computing system described above according to embodiments of the invention.

FIG. 13b illustrates an exemplary digital audio/video player that can include the sensor panel and touchscreen stackups and computing system described above according to embodiments of the invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

This relates to a substantially transparent mutual-capacitance touch sensor panel having sensors fabricated on a single side of a substrate for detecting multi-touch events (the touching of multiple fingers or other objects upon a touch-sensitive surface at distinct locations at about the same time). To avoid having to fabricate substantially transparent row and column traces on opposite sides of the same substrate, embodiments of the invention can form the row and column traces on the same side of the substrate, separated by a thin dielectric material, using diamond, rectangular, or hexagonal rows and columns. Dummy shapes of the same material as the row and column traces can be formed alongside the rows and columns to provide optical uniformity. The metal traces in the border areas used to route the rows to the short edge of the substrate can also be formed on the same side of the substrate as the rows and columns. The metal traces can allow both the rows and columns to be routed to the same short edge of the substrate so that a small flex circuit can be bonded to a small area on only one side of the substrate.

Although some embodiments of this invention may be described herein in terms of mutual capacitance multi-touch sensor panels, it should be understood that embodiments of this invention are not so limited, but are additionally applicable to self-capacitance sensor panels and single-touch sensor panels. Furthermore, although the touch sensors in the sensor panel may be described herein in terms of an orthogonal array of touch sensors having rows and columns, embodiments of this invention are not limited to orthogonal arrays, but can be generally applicable to touch sensors arranged in any number of dimensions and orientations, including diagonal, concentric circle, three-dimensional and random orientations. In addition, although the columns are generally described herein as being on top of the rows, it should be understood that the rows can be on top of the columns to achieve different sensor panel performance.

A DITO mutual capacitance touch sensor panel, with rows and column traces in perpendicular orientations on opposite sides of a glass substrate, can create about 1 pF of static mutual capacitance at each intersection of the row and column traces. However, if this same technique and pattern was applied to rows and columns on the same side of a substrate, the much smaller thickness of the dielectric between the rows and columns can create a large static mutual capacitance. As a result, the touching of a finger or other object will only cause a small change in the large static mutual capacitance, making it difficult to detect the touching of a finger.

For example, in a DITO mutual capacitance touch sensor panel with rows having about 1 pF of static mutual capacitance at each pixel, the presence of a finger will change this capacitance by about 0.1 pF or 10%. However, with the rows and columns on the same side and separated only by a thin dielectric, the static mutual capacitance is on the order of 100 times greater or about 100 pF. Nevertheless, the touching of a finger would still only change this capacitance by about 0.1 pF or 0.1%. Because the sensitivity would be only one part in a thousand, it can be very difficult to detect the touching of a finger.

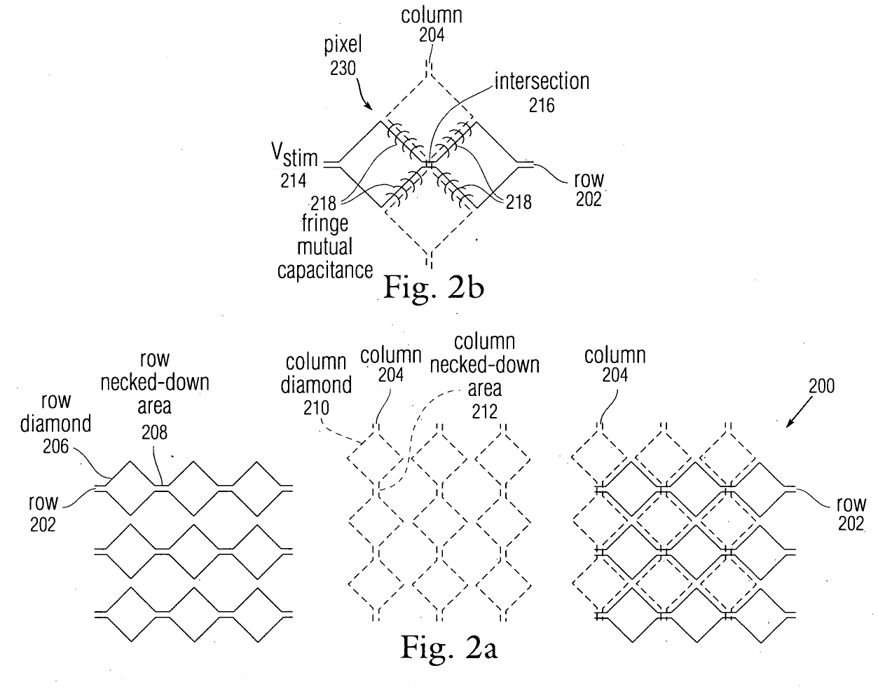

FIG. 2a illustrates exemplary arrangement 200 of diamond-shaped rows and columns (separated by a dielectric material) on the same side of a single substrate that generates about the same amount of static mutual capacitance between the row and column traces as with DITO, according to embodiments of the invention. Note that the spatial density of pixels in the arrangement can be made similar to previously disclosed sensor panels, as spatial density can be dependent on the geometry of the diamond-shaped rows and columns. Note also that FIG. 2a shows diamond-shaped rows 202 and diamond-shaped columns 204 separately and superimposed at 200. In FIG. 2a, each row 202 can be formed from diamond-shaped areas of substantially transparent ITO 206 connected at adjacent facing points by necked-down area 208. Each column can be similarly formed from diamond-shaped areas of substantially transparent ITO 210 connected at adjacent facing points by necked-down area 212. Columns 204 can be connected to a pre-amplifier held at a virtual ground of, for example, 1.5V, and one or more rows 202 can be stimulated with the others held at direct current (DC) voltage levels.

FIG. 2b illustrates exemplary pixel 230 generated from diamond-shaped rows 202 and columns 204 on the same side of a single substrate according to embodiments of the invention. If row 202 is stimulated with a stimulation signal Vstim 214, a static mutual capacitance can be formed at intersection 216 of the necked-down areas. The static mutual capacitance at intersection 216 is undesirable because a finger will not be able to block many of the fringing fields. Accordingly, in this embodiment the necked-down areas are made as small as possible.

A fringe mutual capacitance 218 can also be formed between the diamonds in the stimulated row and the adjacent column diamonds. Fringe mutual capacitance 218 between adjacent diamonds can be of roughly the same order as the mutual capacitance formed between rows and columns separated by a substrate. Fringe mutual capacitance 218 between adjacent row and column diamonds is desirable because a finger will be able to block many of the fringing fields and effect a change in the mutual capacitance that can be detected by the analog channels connected to the rows. As shown in FIG. 2b, there can be four “hot spots” of fringing mutual capacitance indicated at 218 that can be blocked by a finger, and the more that a finger blocks, the greater the change in the signal capacitance.

Columns 204 and rows 202 can be arranged such that the row diamonds and column diamonds do not appear on directly opposing sides of the dielectric material. If the same ITO is used for both the rows and columns, and each layer of ITO is formed over the same material, such an arrangement can produce optical uniformity, because the substrate is “covered” from an orthogonal perspective by either the row or column diamonds of the same ITO on either side of the substrate.

However, if different types of ITO are needed to form the rows and columns on the top and bottom sides of the dielectric, or if the same ITO is deposited on different materials, the configuration described above may not provide optical uniformity due to the dissimilarity of the materials and the fact that the substrate is not uniformly and substantially covered by diamonds of the same ITO chemistries. For example, rows of ITO can be deposited directly onto a glass substrate, then covered with an organic polymer having dielectric properties. Columns of ITO can then be deposited over the organic polymer. Even though both layers of ITO may be of the same composition, because they were deposited over different materials, their composition or chemistry can differ, and their optical properties can be slightly different. As a result, the patterns of rows and column can be visible to a user, which is generally undesirable.

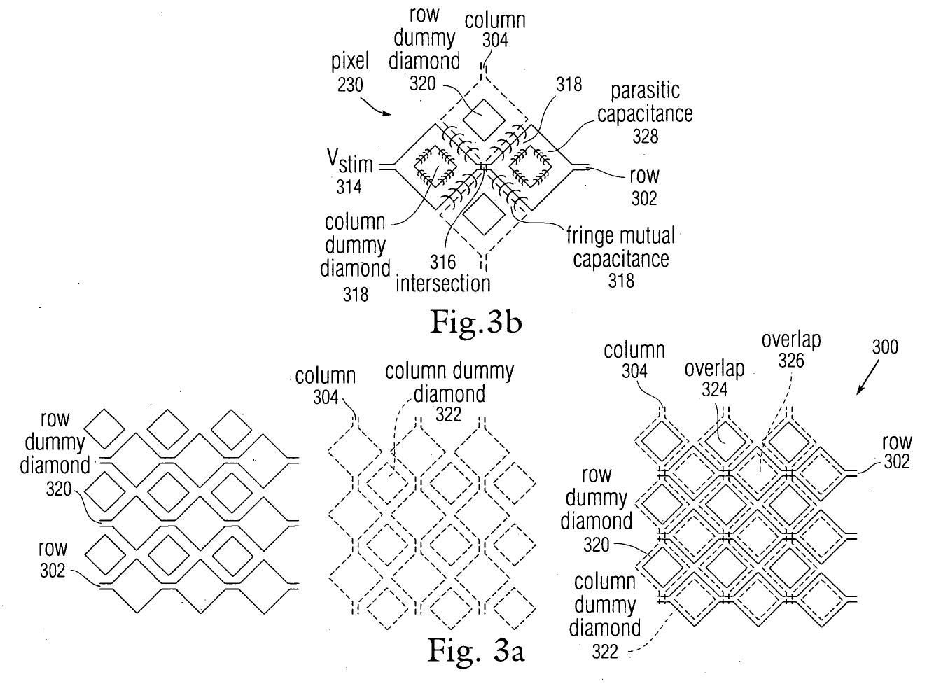

FIG. 3a illustrates exemplary arrangement 300 of diamond-shaped rows and columns, with isolated “dummy” diamonds formed between the rows and columns according to embodiments of the invention. Note that the substrate upon which the rows and columns are supported, along with the dielectric layer between the rows and columns, are not shown in FIG. 3a for purposes of clarity. In particular, dummy diamonds 320 of the same ITO composition as rows 302 can be formed between the rows on the same layer as the rows, and dummy diamonds 322 of the same ITO composition as columns 304 can be formed between the columns on the same layer as the columns. Note that FIG. 3a shows diamond-shaped rows 302 and diamond-shaped columns 304 along with their dummy diamonds 320 and 322 superimposed at 300. In particular, in the arrangement of FIG. 3a, dummy diamonds 320 substantially cover columns 304, and dummy diamonds 322 substantially cover rows 302. Because of the dummy diamonds, almost all areas of the substrate can be covered (i.e. substantially covered) by both types of ITO (see, e.g., areas 324 and 326), providing optical uniformity even if the composition of the row and column ITO is different.

FIG. 3b illustrates exemplary column 304, row 302, and dummy diamonds 322 and 320 according to embodiments of the invention. Note that the dummy diamonds are drawn smaller for purposes of clarity. A large parasitic mutual capacitance 328 can be formed between the stimulated row and the dummy diamonds 322 on the column layer, but because the dummy diamonds are isolated, their voltage potential will move along with the stimulated row and should not have a major impact on finger detection. A fringe mutual capacitance 318 can also be formed between the diamonds in the stimulated row and the adjacent column diamonds. Fringe mutual capacitance 318 between adjacent diamonds can be of roughly the same order as the mutual capacitance formed between rows and columns separated by a substrate. Fringe mutual capacitance 318 between adjacent row and column diamonds can be desirable because a finger will be able to block many of the fringing fields and effect a change in the mutual capacitance that can be detected by the analog channels connected to the rows. As shown in FIG. 3b, there can be four “hot spots” of fringing mutual capacitance at 318 that can be blocked by a finger, and the more that a finger blocks, the greater the change in the signal capacitance.

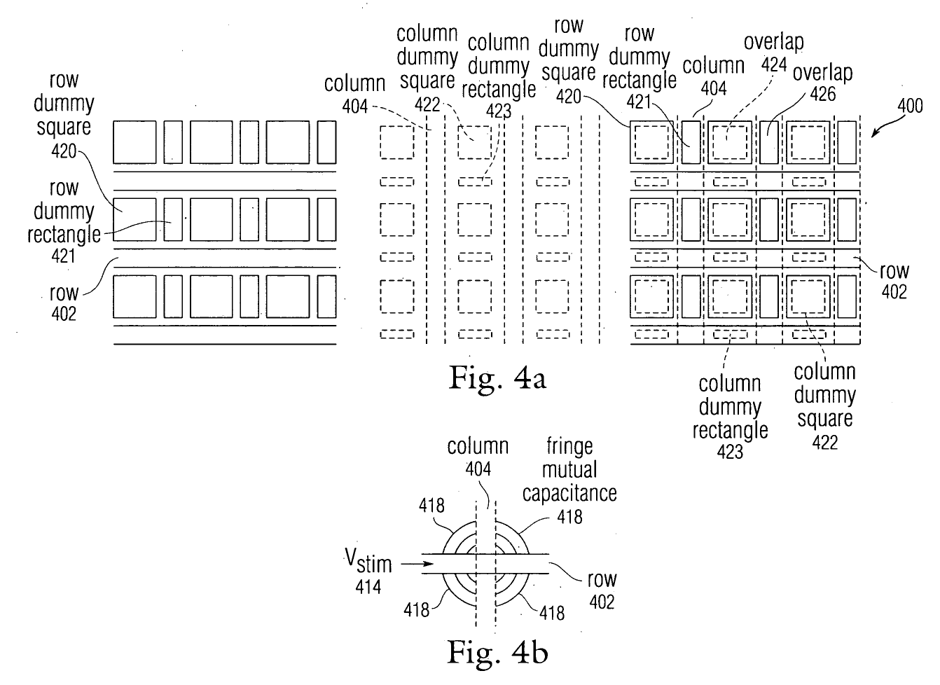

FIG. 4a illustrates exemplary arrangement 400 of rectangular or line-shaped rows and columns, with isolated “dummy” squares and rectangles that can be formed between the rows and columns according to embodiments of the invention. Note that the substrate upon which the rows and columns can be supported, along with the dielectric layer between the rows and columns, are not shown in FIG. 4a for purposes of clarity. In particular, dummy squares 420 and rectangles 421 of the same ITO composition as rows 402 can be formed between the rows on the same layer as the rows, and dummy squares 422 and rectangles 423 of the same ITO composition as columns 404 can be formed between the columns on the same layer as the columns. Note that FIG. 4a shows rows 402 and columns 404 along with their dummy squares and rectangles 420, 421, 422 and 423 superimposed at 400. In particular, in the arrangement of FIG. 4a, dummy rectangles 421 substantially cover columns 404, and dummy rectangles 423 substantially cover rows 402. Because of the dummy squares and rectangles, almost all areas of the substrate are covered by both types of ITO (see, e.g., areas 424 and 426), providing optical uniformity even if the composition of the row and column ITO is different.

FIG. 4b illustrates exemplary column 404 and row 402 according to embodiments of the invention. Note that the dummy squares and rectangles are not shown for purposes of clarity. A fringe mutual capacitance 418 can also be formed between the stimulated row and the adjacent columns. Fringe mutual capacitance 418 can be of roughly the same order as the mutual capacitance formed between rows and columns separated by a substrate. Fringe mutual capacitance 418 between adjacent rows and columns can be desirable because a finger will be able to block many of the fringing fields and effect a change in the mutual capacitance that can be detected by the analog channels connected to the rows. As shown in FIG. 4b, there can be four “hot spots” of fringing mutual capacitance at 418 that can be blocked by a finger, and the more that a finger blocks, the greater the change in the signal capacitance.

One advantage of the diamond-shaped rows and columns shown in FIGS. 3a and 3b is that the necked-down areas (“pinch points”), which create undesirable high resistance junctions, are limited to small areas, and within the diamonds the resistance is not an issue. However, with the rows and columns of FIGS. 4a and 4b, the entire length of the row can be essentially a pinch point.

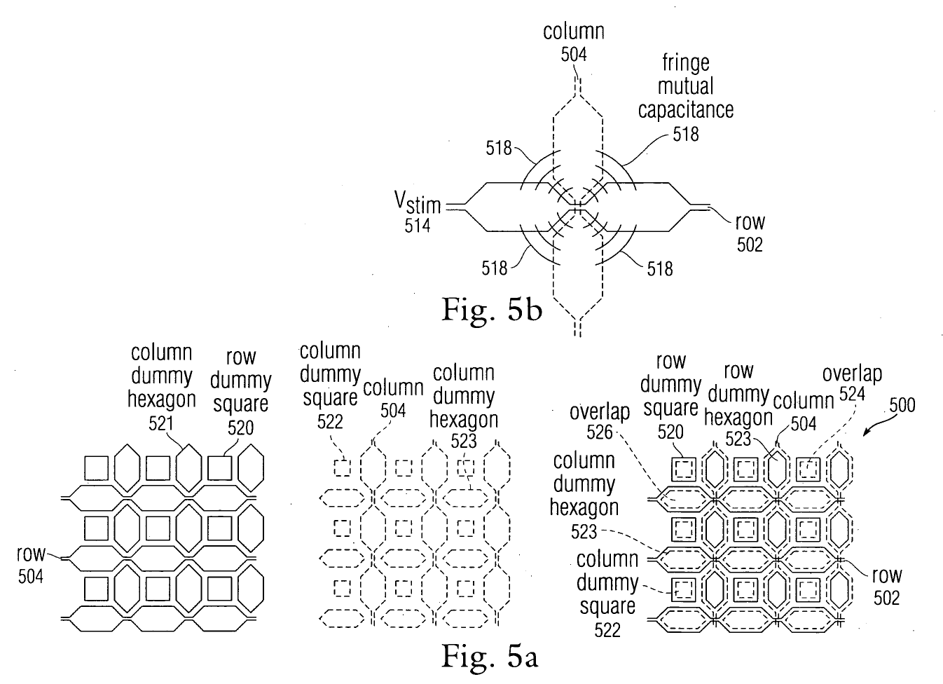

FIG. 5a illustrates exemplary arrangement 500 of hexagon-shaped rows and columns, with isolated “dummy” squares and hexagons formed between the rows and columns according to embodiments of the invention. FIG. 5a is intended to reduce the pinch points and resistance described above by widening the rows and columns, and represents a middle ground between the embodiments of FIGS. 3 and 4. Those skilled in the art will know that there can be a number of different variations between the embodiments of FIGS. 3 and 4 according to embodiments of the invention, of which FIG. 5 is just one example. Note that the substrate upon which the rows and columns can be supported, along with the dielectric layer between the rows and columns, are not shown in FIG. 5a for purposes of clarity. In particular, dummy hexagons 521 and squares 520 of the same ITO composition as rows 502 can be formed between the rows on the same layer as the rows, and dummy squares 522 and hexagons 523 of the same ITO composition as columns 504 can be formed between the columns on the same layer as the columns. Note that FIG. 5a shows hexagon-shaped rows 502 and hexagon-shaped columns 504 along with their dummy squares and rectangles 520, 521, 522 and 523 superimposed at 500. In particular, in the arrangement of FIG. 5a, dummy hexagons 521 substantially cover columns 504, and dummy hexagons 523 substantially cover rows 502. Because of the dummy squares and rectangles, almost all areas of the substrate can be covered by both types of ITO (see, e.g., areas 524 and 526), providing optical uniformity even if the composition of the row and column ITO is different.

FIG. 5b illustrates exemplary column 504 and row 502 according to embodiments of the invention. Note that the dummy hexagons and rectangles are not shown for purposes of clarity. A fringe mutual capacitance 518 can also be formed between the stimulated row and the adjacent columns. Fringe mutual capacitance 518 can be of roughly the same order as the mutual capacitance formed between rows and columns separated by a substrate. Fringe mutual capacitance 518 between adjacent rows and columns can be desirable because a finger will be able to block many of the fringing fields and effect a change in the mutual capacitance that can be detected by the analog channels connected to the rows. As shown in FIG. 5b, there can be four “hot spots” of fringing mutual capacitance at 518 that can be blocked by a finger, and the more that a finger blocks, the greater the change in the signal capacitance.

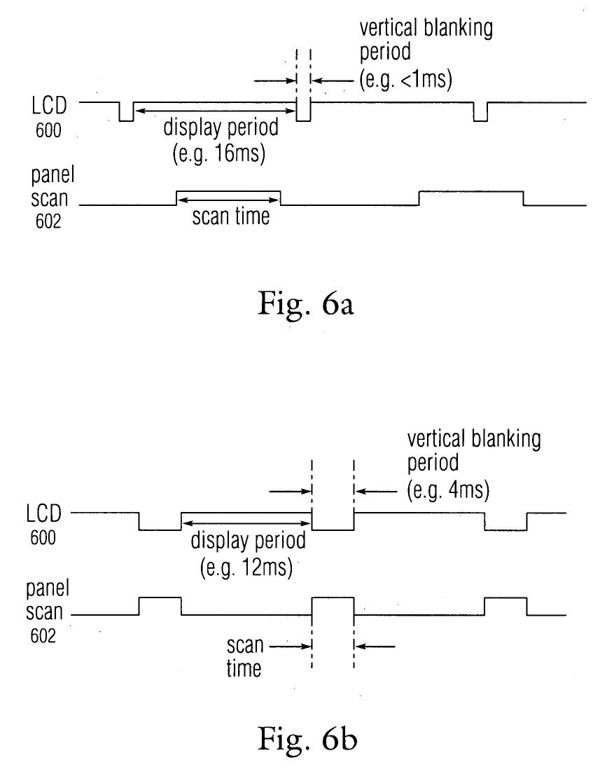

FIG. 6a illustrates an exemplary timing diagram of LCD display activity 600 versus touch sensor panel scan activity 602. Note that the timing is not synchronized, so that a panel scan may be occurring at the same time as LCD display activity (when the Vcom layer and other display-related voltages may be changing state), which causes noise. To prevent this noise from coupling into the column traces of the sensor panel, shielding can be provided.

In some embodiments, this shielding can be provided by the row traces themselves. However, in the embodiments of FIGS. 3-6, dummy squares, rectangles or hexagons can be present alongside the row traces, but unconnected to the row traces. These floating areas do not provide adequate shielding because they are isolated and not driven or tied to DC or ground. Thus, in the embodiments of FIGS. 3-6, LCD shielding is required.

FIG. 6b illustrates an exemplary timing diagram of LCD display activity 600 versus touch sensor panel scan activity 602, where the timing of the LCD display activity and touch panel scanning is synchronized so that scanning only occurs when the LCD display is inactive, during the vertical blanking period, according to embodiments of the invention. With this embodiment, no shielding is required. The staggering of LCD and scanning activity can be accomplished by providing a much longer blanking period to account for the relatively long scan time of conventional panel scanning methods.

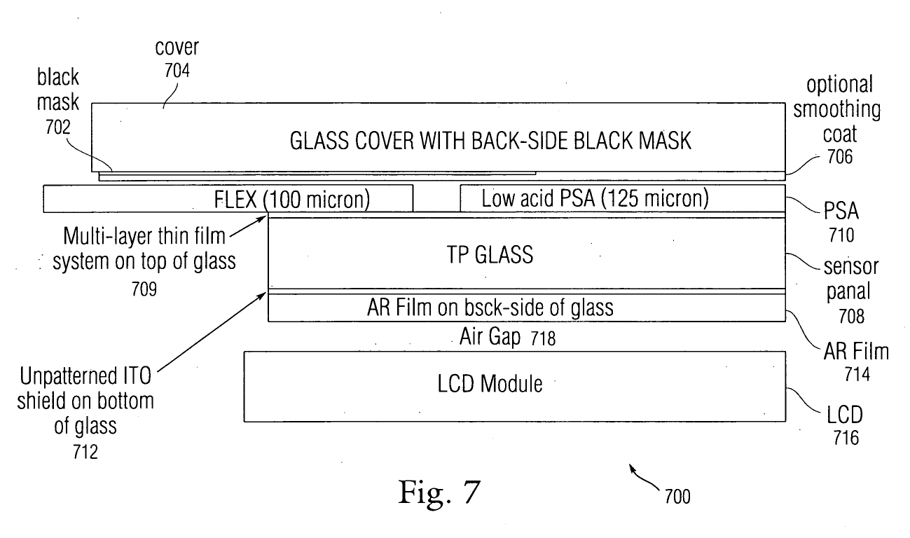

FIG. 7 illustrates exemplary touchscreen stackup 700 according to embodiments of the invention. In FIG. 7, black mask (or a mask of any color) 702 can be formed on a portion of the back side of cover 704, and an optional smoothing coat 706 can be applied over the black mask and back side of the cover. Touch panel 708 of the type described above, with rows and columns formed on the same side of a substrate (represented by dashed line 709 in FIG. 7), can be bonded to the cover with pressure sensitive adhesive (PSA) 710. An unpatterned layer of ITO 712 can optionally be formed on the bottom of the glass to act as a shield. Anti-reflective film 714 can then be deposited over unpatterned ITO 712. LCD module 716 can then be placed beneath the glass substrate, optionally separated by air gap 718 for ease of repair.

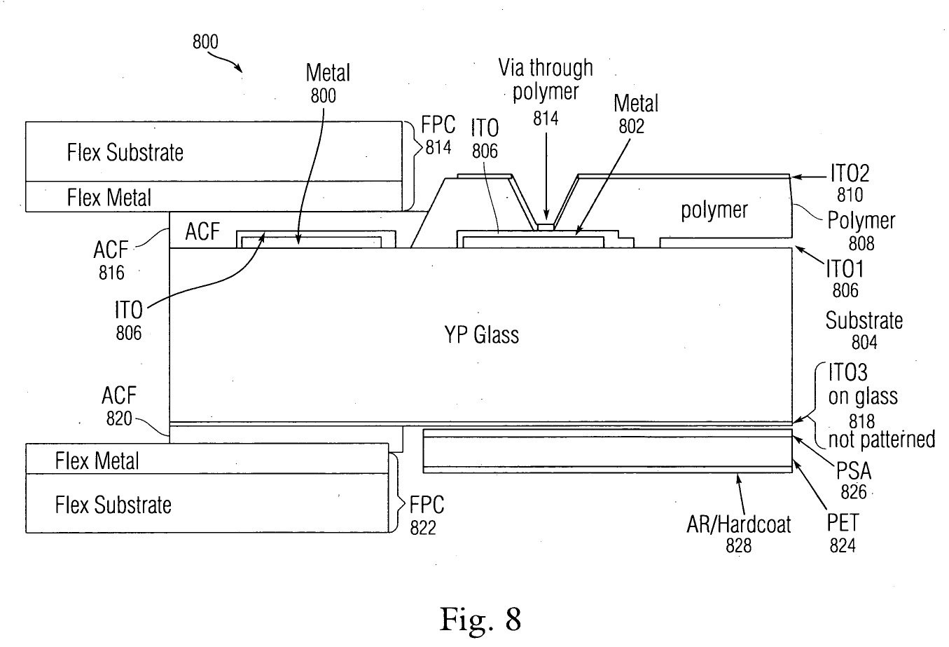

FIG. 8 illustrates exemplary detailed view 800 of the stackup of the rows and columns formed on a single side of a substrate according to embodiments of the invention. In FIG. 8, metal layer 802 (having a resistivity of 0.4 ohms per square maximum, for example) for routing the row traces to a short edge of the substrate can be formed directly on glass substrate 804 and patterned. A first layer 806 of ITO1 (having a resistivity of 200 ohms per square maximum, for example) can then be formed on substrate 804 and patterned. ITO1 806 can contact metal 802, and can be formed and patterned to remain over the metal for corrosion protection, which can improve the reliability of the connections. Alternatively, ITO1 806 can be formed on substrate 804 before metal layer 802. However, if the metal layer is put over the ITO1, the metal must be more corrosion resistant, which can be more expensive.

A layer of clear, photo-imageable organic polymer 808 (patternable by exposing it to light and removing the exposed part or the non-exposed part) having a low dielectric constant (low can be better to create the least amount of capacitance between rows and columns) and a thickness of 3 microns ±20%, for example, can then be formed over ITO1 806 and patterned. Photo-imagable clear polymer can be used because it has a lower dielectric constant, and therefore creates less mutual capacitance. A second layer of ITO2 810 (having a resistivity of 500 ohms per square maximum, for example) can then be sputtered over polymer 808 and patterned. Because ITO2 810 is generally sputtered onto polymer 808, it can generally be of lower quality and higher resistivity as compared to ITO1, which is clearer and has less color shift. ITO1 and ITO2 can be the same, or of a different composition, or they can be the same and yet have different chemistries or properties due to their deposition onto different materials. For example, note that in the example of FIG. 8, ITO2 can have a higher resistance than ITO1, because it can be easier to form a uniform layer over glass as opposed to a polymer. Vias 812, formed by patterning, allow ITO2 810 to connect to metal 802, so that a single layer of metal can be used to route both ITO1 and ITO2 to flexible printed circuit (FPC) 814. Note that in the example of FIG. 8, ITO2 contacts ITO1, which contacts the metal. If ITO1 was sputtered first, ITO2 would contact the metal directly.

In the example of FIG. 8, there can be four mask steps for the top layer, one each for the metal, ITO1, polymer and ITO2. The metal, ITO1 and ITO2 can be patterned to form 20 micron ±3 micron lines and spaces, for example. Anisotropic conductive film (ACF) 816 can then be used to bond flex circuit 814 to metal traces 802 on substrate 804. The ACF can form a conductive bond with the metal on the flex circuit.

A shield layer of unpatterned ITO3 818 (having a resistivity of 200 ohms per square maximum, for example) can be formed on the bottom side of glass substrate 804. ACF 820 can be used to bond flex circuit 822 to shield layer 818 and ground it. A PET substrate 824 (having a thickness of 50 microns, for example) can be bonded to glass 804 using PSA 826 (having a thickness of 25 microns, for example), and an anti-reflective hardcoat 828 can be applied to the PET.

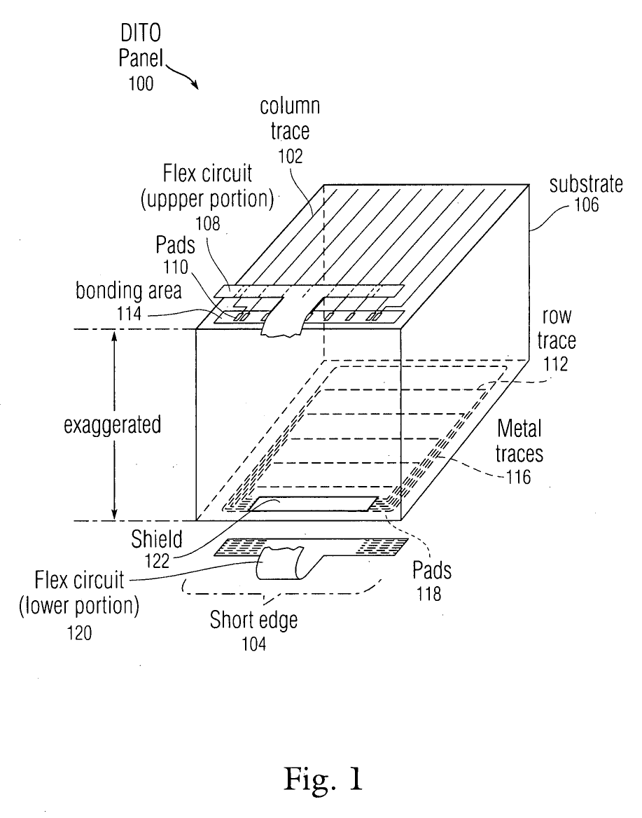

One advantage of using the diamond-shaped rows and columns according to embodiments of the invention is that a single layer of metal routing can be used to route both the rows and the columns to the same short edge of the substrate. In previous designs (see FIG. 1), the rows had metal traces along the borders, but the columns did not, and thus a wide FPC was required for the columns. However, in embodiments of the invention, with rows and columns on the same side, metal traces can be used to connect up to both drive the rows and sense the columns, and fan them into a narrow region for flex bonding.

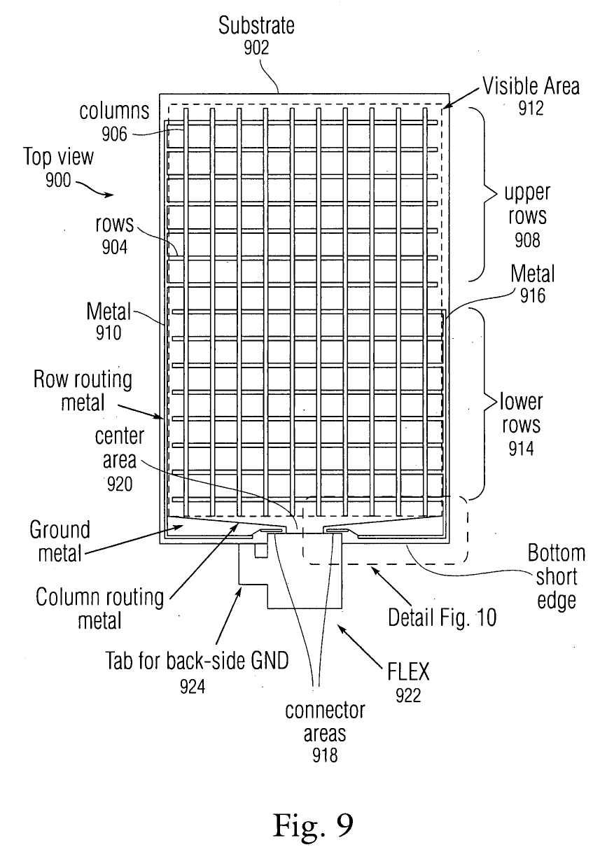

FIG. 9 illustrates top view 900 of exemplary substrate 902 with rows 904 and columns 906 formed on the top side and connected at a single end according to embodiments of the invention. In FIG. 9, the grid of rows and columns is symbolic—the rows and columns can be diamond-shaped, rectangular, or any of a number of shapes as described above. 15 micron patterning can be used to allow for the same mechanical control outline (MCO) (i.e. the same physical envelope) as previous designs. Upper rows 908 can be connected to the bottom short edge of substrate 902 using metal traces 910 running along the left border of the substrate, outside visible area 912. Lower rows 914 can be connected to the bottom short edge of substrate 902 using metal traces 916 running along the right border of the substrate, outside visible area 912. By connecting the rows to metal traces at only one end, the metal traces can take up less width in the border areas and can be made wider, lowering their resistivity. The metal traces connecting the rows can be connected to bond pads in small connector areas 918 near the middle of the bottom short edge of substrate 902. The column traces can be routed to center 920 of the small connector area using metal traces. Note that flex circuit 922 in FIG. 9 can be made very small, and includes tab 924 for connecting to a shield layer on the back side of the substrate.

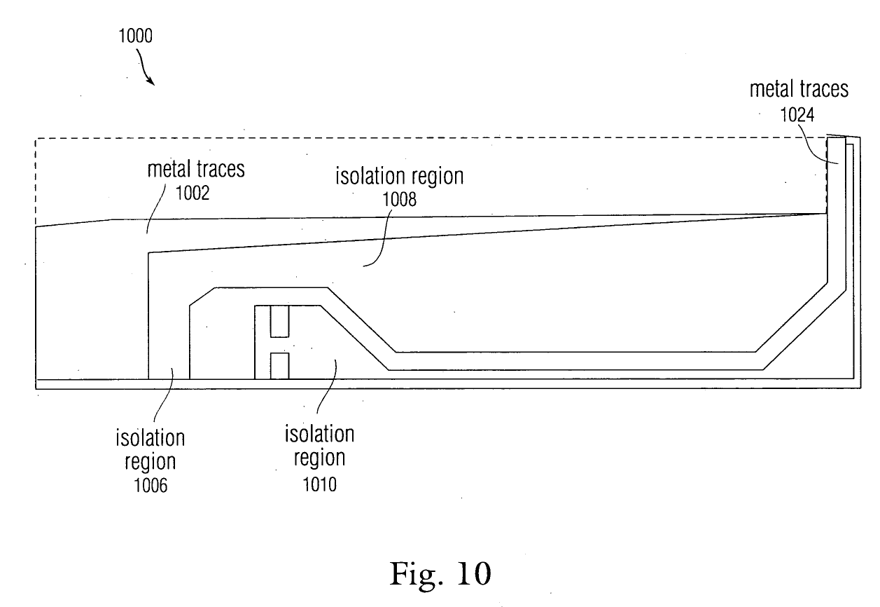

FIG. 10 illustrates expanded view 1000 of exemplary metal traces as they are routed to the bond pads at the bottom short edge of the substrate according to embodiments of the invention. In FIG. 10, areas 1002 and 1004 actually represent many metal traces. Areas 1006, 1008 and 1010 adjacent to areas 1002 and 1004 represent continuous isolation regions that can be connected to bond pads which are then ultimately grounded to reduce coupling (undesired mutual capacitance) between the row traces routed through areas 1004 and the column traces routed through 1002.

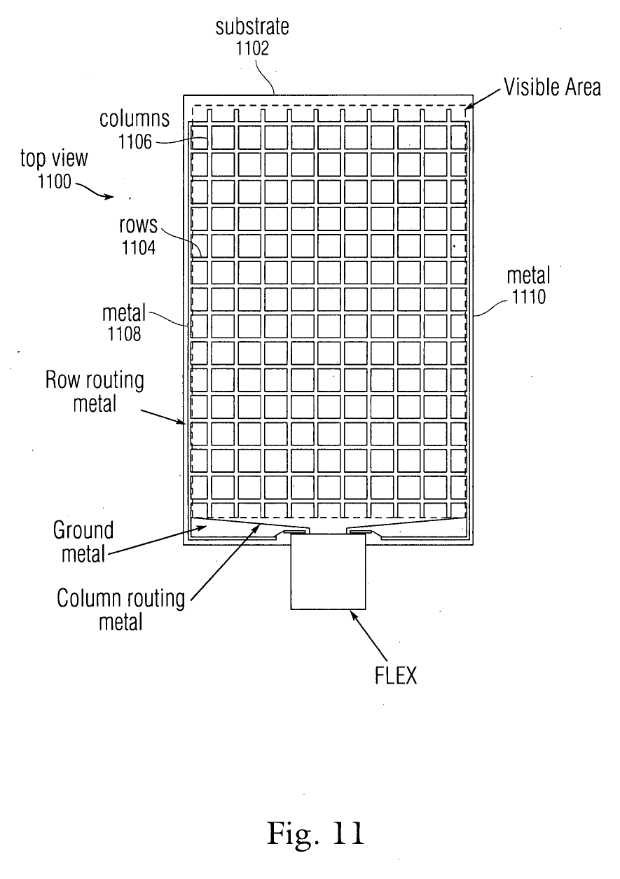

FIG. 11 illustrates top view 1100 of exemplary substrate 1102 with rows 1104 and columns 1106 formed on the top side and with rows connected at both ends according to embodiments of the invention. In the dual row, single column embodiment of FIG. 11, all rows 1104 can be connected on both the left and right sides by metal traces 1108 and 1110 running within the left and right borders of substrate 1102. Because rows 1104 only need to be driven for half of the width of substrate 1102, the phase delay differences between rows is reduced. However, one drawback is that because double the number of metal traces can be needed as compared to FIG. 11, the traces must be made narrow, which increases their resistivity.

It should also be noted that in alternative embodiments of the invention, the columns can also be connected from either or both sides, and the rows and columns can be routed on either the top or bottom ITO layers.

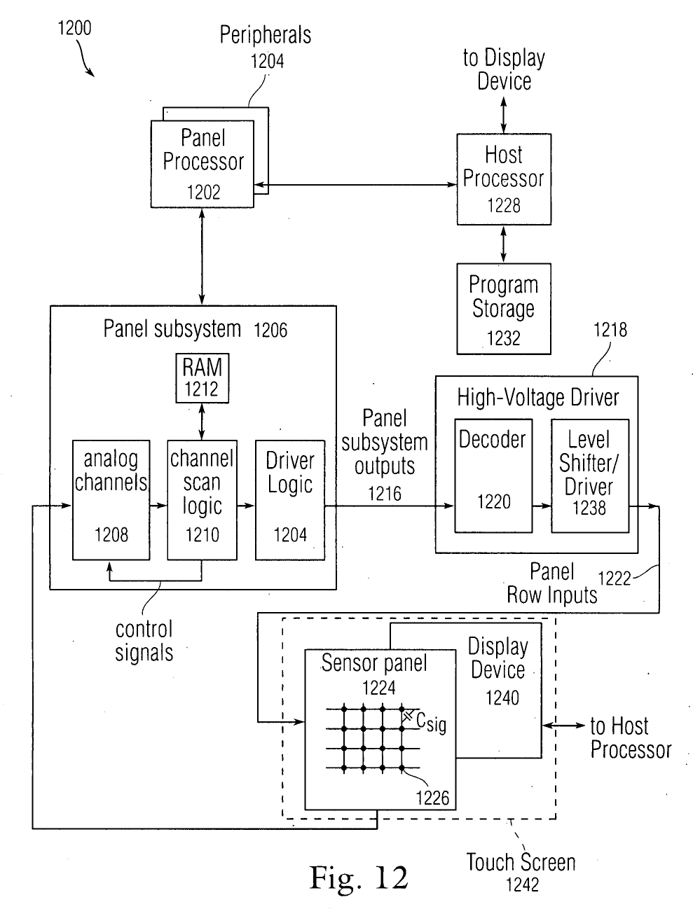

FIG. 12 illustrates exemplary computing system 1200 operable with the sensor panel and touchscreen stackups described above according to embodiments of this invention. Touchscreen 1242, which can include sensor panel 1224 and display device 1240 (e.g. an LCD module), can be connected to other components in computing system 1200 through connectors integrally formed on the sensor panel, or using flex circuits. Computing system 1200 can include one or more panel processors 1202 and peripherals 1204, and panel subsystem 1206. The one or more processors 1202 can include, for example, ARM968 processors or other processors with similar functionality and capabilities. However, in other embodiments, the panel processor functionality can be implemented instead by dedicated logic such as a state machine. Peripherals 1204 can include, but are not limited to, random access memory (RAM) or other types of memory or storage, watchdog timers and the like.

Panel subsystem 1206 can include, but is not limited to, one or more analog channels 1208, channel scan logic 1210 and driver logic 1214. Channel scan logic 1210 can access RAM 1212, autonomously read data from the analog channels and provide control for the analog channels. This control can include multiplexing columns of multi-touch panel 1224 to analog channels 1208. In addition, channel scan logic 1210 can control the driver logic and stimulation signals being selectively applied to rows of multi-touch panel 1224. In some embodiments, panel subsystem 1206, panel processor 1202 and peripherals 1204 can be integrated into a single application specific integrated circuit (ASIC).

Driver logic 1214 can provide multiple panel subsystem outputs 1216 and can present a proprietary interface that drives high voltage driver 1218. High voltage driver 1218 can provide level shifting from a low voltage level (e.g. complementary metal oxide semiconductor (CMOS) levels) to a higher voltage level, providing a better signal-to-noise (S/N) ratio for noise reduction purposes. Panel subsystem outputs 1216 can be sent to decoder 1220 and level shifter/driver 1238, which can selectively connect one or more high voltage driver outputs to one or more panel row inputs 1222 through a proprietary interface and enable the use of fewer high voltage driver circuits in the high voltage driver 1218. Each panel row input 1222 can drive one or more rows in a multi-touch panel 1224. In some embodiments, high voltage driver 1218 and decoder 1220 can be integrated into a single ASIC. However, in other embodiments high voltage driver 1218 and decoder 1220 can be integrated into driver logic 1214, and in still other embodiments high voltage driver 1218 and decoder 1220 can be eliminated entirely.

Computing system 1200 can also include host processor 1228 for receiving outputs from panel processor 1202 and performing actions based on the outputs that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 1228 can also perform additional functions that may not be related to panel processing, and can be coupled to program storage 1232 and display device 1240 such as an LCD for providing a user interface (UI) to a user of the device.

As mentioned above, multi-touch panel 1224 can in some embodiments include a capacitive sensing medium having a plurality of row traces or driving lines and a plurality of column traces or sensing lines separated by a dielectric. In some embodiments, the dielectric material can be transparent, such as PET or glass. The row and column traces can be formed from a transparent conductive medium such as ITO or antimony tin oxide (ATO), although other non-transparent materials such as copper can also be used. In some embodiments, the row and column traces can be perpendicular to each other, although in other embodiments other non-orthogonal orientations are possible. For example, in a polar coordinate system, the sensing lines can be concentric circles and the driving lines can be radially extending lines (or vice versa). It should be understood, therefore, that the terms “row” and “column,” “first dimension” and “second dimension,” or “first axis” and “second axis” as may be used herein are intended to encompass not only orthogonal grids, but the intersecting traces of other geometric configurations having first and second dimensions (e.g. the concentric and radial lines of a polar-coordinate arrangement).

At the “intersections” of the traces, where the traces pass above and below each other (but do not make direct electrical contact with each other), the traces essentially form two electrodes. Each intersection of row and column traces can represent a capacitive sensing node and can be viewed as picture element (pixel) 1226, which can be particularly useful when multi-touch panel 1224 is viewed as capturing an “image” of touch. (In other words, after panel subsystem 1206 has determined whether a touch event has been detected at each touch sensor in multi-touch panel 1224, the pattern of touch sensors in the multi-touch panel at which a touch event occurred can be viewed as an “image” of touch (e.g. a pattern of fingers touching the panel).) When the two electrodes are at different potentials, each pixel can have an inherent self or mutual capacitance formed between the row and column electrodes of the pixel. If an AC signal is applied to one of the electrodes, such as by exciting the row electrode with an AC voltage at a particular frequency, an electric field and an AC or signal capacitance can be formed between the electrodes, referred to as Csig. The presence of a finger or other object near or on multi-touch panel 1224 can be detected by measuring changes to Csig. The columns of multi-touch panel 1224 can drive one or more analog channels 1208 in panel subsystem 1206. In some embodiments, each column is coupled to one dedicated analog channel 1208. However, in other embodiments, the columns can be couplable via an analog switch to a fewer number of analog channels 1208.

The sensor panel and touchscreen stackups described above can be advantageously used in the system of FIG. 12 to provide a space-efficient touch sensor panel and UI that is lower cost, more manufacturable, fits into existing mechanical control outlines (the same physical envelope).

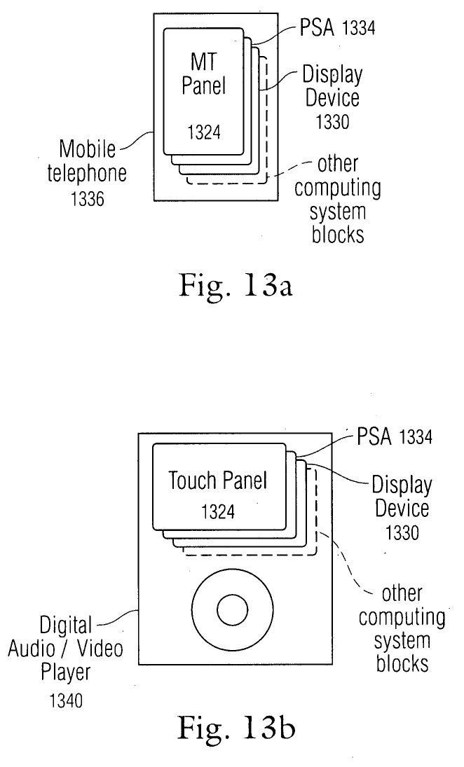

FIG. 13a illustrates exemplary mobile telephone 1336 that can include sensor panel 1324 and display device 1330 stackups (optionally bonded together using PSA 1334) and computing system described above according to embodiments of the invention. FIG. 13b illustrates exemplary digital audio/video player 1340 that can include sensor panel 1324 and display device 1330 stackups (optionally bonded together using PSA 1334) and computing system described above according to embodiments of the invention. The mobile telephone and digital audio/video player of FIGS. 13a and 13b can advantageously benefit from the touchscreen stackups described above because the touchscreen stackups allow these devices to be smaller and less expensive, which are important consumer factors that can have a significant effect on consumer desirability and commercial success.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A substantially transparent touch sensor panel, comprising:
a plurality of first traces of a first substantially transparent conductive material supported on a top side of a substantially transparent substrate;
a plurality of first dummy shapes of the first substantially transparent conductive material formed between the first traces and supported on the top side of the substrate;
a layer of substantially transparent dielectric material formed over the first traces and the first dummy shapes;
a plurality of second traces of a second substantially transparent conductive material supported on the dielectric material; and
a plurality of second dummy shapes of the second substantially transparent conductive material formed between the second traces and supported on the dielectric material;
wherein the first and second traces are arranged with respect to each other to form an array of sensors, each sensor centered at a point at which the first traces cross over the second traces; and
wherein the first traces and first dummy shapes are arranged with respect to the second traces and second dummy shapes to substantially cover the top side of the substrate with a uniform stackup of material for producing substantial optical uniformity.

2. The substantially transparent touch sensor panel of claim 1, wherein the first dummy shapes substantially cover the second traces, and the second dummy shapes substantially cover the first traces.

3. The substantially transparent touch sensor panel of claim 1, the first substantially transparent conductive material being the same as the second substantially transparent conductive material.

4. The substantially transparent touch sensor panel of claim 1, each of the plurality of first and second traces formed as connected diamonds, and each of the plurality of first and second dummy shapes formed as isolated diamonds.

5. The substantially transparent touch sensor panel of claim 1, each of the plurality of first and second traces formed as lines, and each of the plurality of first and second dummy shapes formed as isolated squares and rectangles.

6. The substantially transparent touch sensor panel of claim 1, each of the plurality of first and second traces formed as connected hexagons, and each of the plurality of first and second dummy shapes formed as isolated squares and hexagons.

7. The substantially transparent touch sensor panel of claim 1, further comprising:
a plurality of first metal traces supported on the substrate and connected to the plurality of first traces; and
a plurality of second metal traces supported on the substrate and connected to the plurality of second traces;
wherein the first and second metal traces are routed along border regions of the substrate to an edge of the substrate for providing off-panel connections.

8. The substantially transparent touch sensor panel of claim 7, each first trace having a first end and a second end, the plurality of first metal traces connected to a first number of the first traces at the first end and connected to a second number of the first traces at the second end.

9. The substantially transparent touch sensor panel of claim 7, each first trace having a first end and a second end, the plurality of first metal traces connected to the first traces at both the first end and the second end.

10. The substantially transparent touch sensor panel of claim 7, further comprising a substantially transparent shield layer formed on a bottom side of the substrate for shielding the first traces.

11. The substantially transparent touch sensor panel of claim 7, further comprising a continuous isolation region of conductive material formed on the top of the substrate between the first and second metal traces at the edge of the substrate and held at a fixed potential to reduce coupling between the first and second metal traces.

12. A substantially transparent touch sensor panel, comprising:
a plurality of first traces of a first substantially transparent conductive material and a plurality of second traces of a second substantially transparent conductive material formed on a top side of a substantially transparent substrate and separated by a dielectric layer, the plurality of first and second traces arranged with respect to each other to form an array of sensors, each sensor centered at a point at which a particular first trace crosses over a particular second trace, and each sensor capable of generating a fringe mutual capacitance between the particular first and second traces that can be altered by a touch; and
a plurality of first dummy shapes of the first substantially transparent conductive material formed between the first traces and supported on the top side of the substrate, and a plurality of second dummy shapes of the second substantially transparent conductive material formed between the second traces and supported on the dielectric material;
wherein the first traces and first dummy shapes are arranged with respect to the second traces and second dummy shapes to substantially cover the top side of the substrate with a uniform stackup of material for producing substantial optical uniformity.

13. The substantially transparent touch sensor panel of claim 12, wherein the first dummy shapes substantially cover the second traces, and the second dummy shapes substantially cover the first traces.

14. The substantially transparent touch sensor panel of claim 12, the first substantially transparent conductive material being the same as the second substantially transparent conductive material.

15. The substantially transparent touch sensor panel of claim 12, each of the plurality of first and second traces formed as connected diamonds, and each of the plurality of first and second dummy shapes formed as isolated diamonds.

16. The substantially transparent touch sensor panel of claim 12, each of the plurality of first and second traces formed as lines, and each of the plurality of first and second dummy shapes formed as isolated squares and rectangles.

17. The substantially transparent touch sensor panel of claim 12, each of the plurality of first and second traces formed as connected hexagons, and each of the plurality of first and second dummy shapes formed as isolated squares and hexagons.

18. The substantially transparent touch sensor panel of claim 12, further comprising:
a plurality of first metal traces supported on the substrate and connected to the plurality of first traces; and
a plurality of second metal traces supported on the substrate and connected to the plurality of second traces;
wherein the first and second metal traces are routed along border regions of the substrate to an edge of the substrate for providing off-panel connections.

19. The substantially transparent touch sensor panel of claim 18, each first trace having a first end and a second end, the plurality of first metal traces connected to a first number of the first traces at the first end and connected to a second number of the first traces at the second end.

20. The substantially transparent touch sensor panel of claim 18, each first trace having a first end and a second end, the plurality of first metal traces connected to the first traces at both the first end and the second end.

21. The substantially transparent touch sensor panel of claim 18, further comprising a substantially transparent shield layer formed on a bottom side of the substrate for shielding the first traces.

22. The substantially transparent touch sensor panel of claim 18, further comprising a continuous isolation region of conductive material formed on the top of the substrate between the first and second metal traces at the edge of the substrate and held at a fixed potential to reduce coupling between the first and second metal traces.

23. The substantially transparent touch sensor panel of claim 12, further comprising a display device coupled to the touch sensor panel to form a touchscreen.

24. A computing system comprising the touchscreen of claim 23.

25. A mobile telephone comprising the computing system of claim 24.

26. A digital audio player comprising the computing system of claim 24.

27. A mobile telephone including a substantially transparent touch sensor panel, the substantially transparent touch sensor panel comprising:
a plurality of first traces of a first substantially transparent conductive material and a plurality of second traces of a second substantially transparent conductive material formed on a top side of a substantially transparent substrate and separated by a dielectric layer, the plurality of first and second traces arranged with respect to each other to form an array of sensors, each sensor centered at a point at which a particular first trace crosses over a particular second trace, and each sensor capable of generating a fringe mutual capacitance between the particular first and second traces that can be altered by a touch; and
a plurality of first dummy shapes of the first substantially transparent conductive material formed between the first traces and supported on the top side of the substrate, and a plurality of second dummy shapes of the second substantially transparent conductive material formed between the second traces and supported on the dielectric material;
wherein the first traces and first dummy shapes are arranged with respect to the second traces and second dummy shapes to substantially cover the top side of the substrate with a uniform stackup of material for producing substantial optical uniformity.

28. A digital audio player including a substantially transparent touch sensor panel, the substantially transparent touch sensor panel comprising:
a plurality of first traces of a first substantially transparent conductive material and a plurality of second traces of a second substantially transparent conductive material formed on a top side of a substantially transparent substrate and separated by a dielectric layer, the plurality of first and second traces arranged with respect to each other to form an array of sensors, each sensor centered at a point at which a particular first trace crosses over a particular second trace, and each sensor capable of generating a fringe mutual capacitance between the particular first and second traces that can be altered by a touch; and
a plurality of first dummy shapes of the first substantially transparent conductive material formed between the first traces and supported on the top side of the substrate, and a plurality of second dummy shapes of the second substantially transparent conductive material formed between the second traces and supported on the dielectric material;
wherein the first traces and first dummy shapes are arranged with respect to the second traces and second dummy shapes to substantially cover the top side of the substrate with a uniform stackup of material for producing substantial optical uniformity.

29. A method for forming a substantially transparent touch sensor panel, comprising:
supporting a plurality of first traces of a first substantially transparent conductive material on a top side of a substantially transparent substrate;
forming a plurality of first dummy shapes of the first substantially transparent conductive material between the first traces and supporting the first dummy shapes on the top side of the substrate;
forming a layer of substantially transparent dielectric material over the first traces and the first dummy shapes;
supporting a plurality of second traces of a second substantially transparent conductive material on the dielectric material;
forming a plurality of second dummy shapes of the second substantially transparent conductive material between the second traces and supporting the second dummy shapes on the dielectric material;
arranging the first and second traces with respect to each other to form an array of sensors, each sensor centered at a point at which the first traces cross over the second traces; and
arranging the first traces and first dummy shapes with respect to the second traces and second dummy shapes to substantially cover the top side of the substrate with a uniform stackup of material for producing substantial optical uniformity.

30. The method of claim 29, further comprising substantially covering the second traces with the first dummy shapes, and substantially covering the first traces with the second dummy shapes.

31. The method of claim 29, the first substantially transparent conductive material being the same as the second substantially transparent conductive material.

32. The method of claim 29, further comprising forming each of the plurality of first and second traces as connected diamonds, and forming each of the plurality of first and second dummy shapes as isolated diamonds.

33. The method of claim 29, further comprising forming each of the plurality of first and second traces as lines, and forming each of the plurality of first and second dummy shapes as isolated squares and rectangles.

34. The method of claim 29, further comprising forming each of the plurality of first and second traces as connected hexagons, and forming each of the plurality of first and second dummy shapes as isolated squares and hexagons.

35. The method of claim 29, further comprising:
supporting a plurality of first metal traces on the substrate and connecting the first metal traces to the plurality of first traces;
supporting a plurality of second metal traces on the substrate and connecting the second metal traces to the plurality of second traces; and
routing the first and second metal traces along border regions of the substrate to an edge of the substrate for providing off-panel connections.

36. The method of claim 35, each first trace having a first end and a second end, the method further comprising connecting the plurality of first metal traces to a first number of the first traces at the first end and to a second number of the first traces at the second end.

37. The method of claim 35, each first trace having a first end and a second end, the method further comprising connecting the plurality of first metal traces to the first traces at both the first end and the second end.

38. The method of claim 35, further comprising forming a substantially transparent shield layer on a bottom side of the substrate for shielding the first traces.

39. The method of claim 35, further comprising forming a continuous isolation region of conductive material on the top of the substrate between the first and second metal traces at the edge of the substrate and holding the isolation region at a fixed potential to reduce coupling between the first and second metal traces.

40. A substantially transparent touch sensor panel, comprising:
means for supporting a plurality of first traces of a first substantially transparent conductive material on a top side of a substantially transparent substrate;
means for forming a plurality of first dummy shapes of the first substantially transparent conductive material between the first traces and supporting the first dummy shapes on the top side of the substrate;
means for forming a layer of substantially transparent dielectric material over the first traces and the first dummy shapes;
means for supporting a plurality of second traces of a second substantially transparent conductive material on the dielectric material;
means for forming a plurality of second dummy shapes of the second substantially transparent conductive material between the second traces and supporting the second dummy shapes on the dielectric material;
means for arranging the first and second traces with respect to each other to form an array of sensors, each sensor centered at a point at which the first traces cross over the second traces; and
means for arranging the first traces and first dummy shapes with respect to the second traces and second dummy shapes to substantially cover the top side of the substrate with a uniform stackup of material for producing substantial optical uniformity.
